(19) United States
(12) Patent Application Publication
(10) Pub. No.: US 2006/0129675 A1
(43) Pub. Date: Jun. 15, 2006

(54) System and method to reduce platform power utilization

(75) Inventors: Vincent J. Zimmer, Federal Way, WA (US); Michael A. Rothman, Puyallup, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Intel Corporation

(21) Appl. No.: 10/996,010

(22) Filed: Nov. 22, 2004

(51) Int. Cl. G06F 15/173

(52) U.S. Cl. 709/225

(57) ABSTRACT

In some embodiments, the invention involves utilizing an enhanced round robin DNS (eRR-DNS) scheme to maximize throughput while minimizing power consumption in a network of computers. In at least one embodiment, the present invention is intended to balance the work load of network platforms in order to minimize or optimize power utilization. Other embodiments are described and claimed.

### FIELD OF THE INVENTION

An embodiment of the present invention relates generally to power utilization in a network of computers and, more specifically, to reducing power utilization using a modified round-robin Domain Name System (DNS) technique.

### BACKGROUND INFORMATION

Various mechanisms exist for reducing power utilization of a single platform. Power utilization of network systems can be more problematic. In existing systems using multiple platforms to distribute workload, throughput or user connect time are typically the prime concerns of the network load balancer.

A number of domain name system (DNS) servers on the Internet provide translation from commonly used plain text domain names to Internet Protocol (IP) addresses. When a user types in a uniform resource locator (URL) to a web browser, a server (DNS) on the Internet sees this request in hypertext transfer protocol (HTTP) and takes the URL and converts it to an IP address. (Note, to prevent inadvertent hyperlinks in this document in any of the following URLs, periods in the URLs are replaced with dashes.) The user is now able to communicate with the server.

However, if many users try to access the URL simultaneously, performance and response time may be severely degraded. For instance, a common search tool such as found at URL www-google-com must be able to accommodate many thousands of simultaneous user requests. Similarly, a common on-line shopping network such as may be found at URL www-amazon-com must also be able to accommodate many simultaneous product orders. Existing network servers may balance user requests among many servers which act as mirror sites, but are transparent to the user. A front-end server communicates at the translated IP address and forwards the jobs to one or more back-end servers. From a user's point of view, this network of servers, also known as a “server farm,” appears as a single domain.

Existing network servers may perform what is called “round-robin DNS” (RR-DNS) to alleviate these load balance problems. There may be a front-end server that routes the user request to one of a plurality of servers. The plurality of servers appears to be at the same IP address, to the user. The front-end server distributes the jobs round-robin to the next available server, i.e., the servers may be presumed to be in a large circuit and the next job is routed to the next server in the chain. This distribution continues round and round the chain. In some systems, this round-robin distribution is effected with a switch, rather then a full-fledged server. The RR-DNS typically performs load-balancing by trying to balance the rate, or number of requests per unit of time, across the various back-end servers. This balance can be based upon each of the back-end servers' memory capacity, CPU count, etc.

### BRIEF DESCRIPTION OF THE DRAWINGS

The features and advantages of the present invention will become apparent from the following detailed description of the present invention in which:

FIG. 1 is a block diagram showing an exemplary front-end routing system as used in existing systems for load balancing;

FIG. 2 is a block diagram of an exemplary enhanced round-robin DNS (eRR-DNS) system, according to an embodiment of the invention;

FIG. 3 is a block diagram of an exemplary back-end server communicatively coupled to at least one remote agent, according to an embodiment of the invention; and

FIG. 4 is a flow diagram showing an exemplary method of enhanced load balancing to minimize power consumption, according to an embodiment of the invention.

### DETAILED DESCRIPTION

An embodiment of the present invention is a system and method relating to reducing platform power utilization using an enhanced round-robin DNS (herein referred to as “eRR-DNS”) technique. In at least one embodiment, the present invention is intended to balance the work load of network platforms in order to minimize or optimize power utilization.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

For purposes of explanation, specific configurations and details are set forth in order to provide a thorough understanding of the present invention. However, it will be apparent to one of ordinary skill in the art that embodiments of the present invention may be practiced without the specific details presented herein. Furthermore, well-known features may be omitted or simplified in order not to obscure the present invention. Various examples may be given throughout this description. These are merely descriptions of specific embodiments of the invention. The scope of the invention is not limited to the examples given.

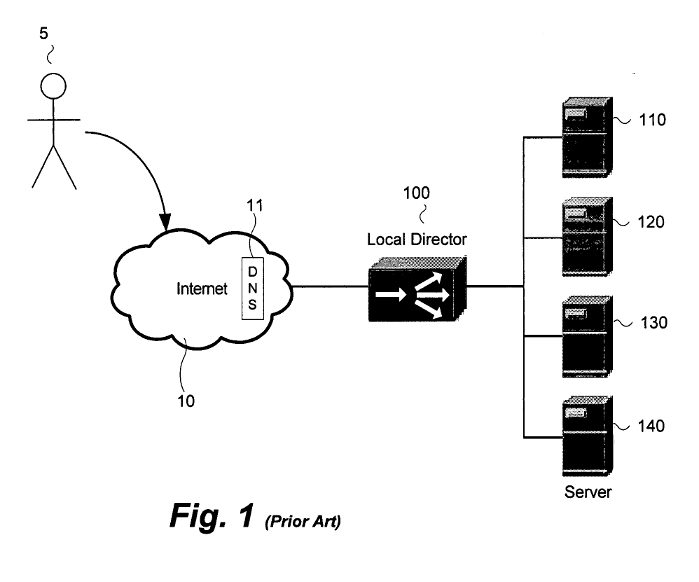

Existing RR-DNS policies may be inefficient. Referring now to the drawings, and specifically to FIG. 1, there is shown an exemplary network of computers. In this exemplary server farm environment, a Cisco Systems LocalDirector Series 400 unit intelligently load balances Transfer Control Protocol/Internet Protocol (TCP/IP) traffic across multiple servers. A user 5 may communicate a request to the Internet 10. A DNS server 11 on the Internet translates the user-given URL to an IP address. In this example, the IP address corresponds to a site managed by front-end server 100, or Local Director. The front-end server balances the work load of user requests among back-end servers 110, 120, 130 and 140.

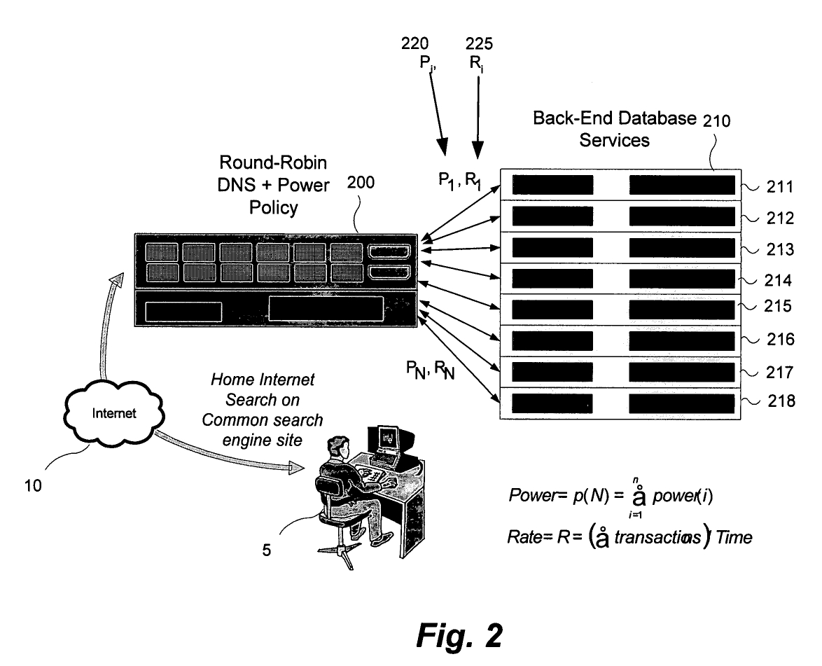

FIG. 2 shows a block diagram of an exemplary network using enhanced RR-DNS (eRR-DNS) to balance work load. A single eRR-DNS front-end server 200 may be connected to a user 5 via a network 10, such as the public Internet. Behind the front-end server 200 is a collection of n replicated back-end database servers 211-218. Each back-end server i will support a given rate Rᵢ 220 and dissipate some power Pᵢ 225. To ascertain the power measurements, out-of-band messaging or in-band messaging from the back-end database server operating systems may provide the current power dissipation for each platform. The rate may be tracked by the eRR-DNS server.

For example, the network may comprise a front-end server 200 and back-end servers 211-218 (collectively, 210). When a user 5 requests the network to perform a job, for instance a network search, the front-end server 200 may use a round robin policy combined with a power policy, as described herein. In an embodiment of the system and method as described herein, back-end servers 210 may communicate power consumption information Pᵢ to the front-end server 200. The back-end server 210 may communicate how much power is being dissipated, as well as, the amount of work, or load Rᵢ, of the server. In some embodiments, the front-end server uses throughput information derived from Job start and end times to determine rate or load of an individual server.

In large data centers, or server farms, with many back-end servers, it may be desirable to minimize the costs of power and cooling. A power efficient method of distributing work may be to select the back-end server that is using the least amount of power to perform the most amount of work. Round-robin techniques, as used in existing systems, alone, may merely maximize throughput. Embodiments of the present system and method may minimize or optimize power consumption.

Traditional RR-DNS is policy based on load balancing and throughput. Embodiments of the present invention add a power consumption element to create an enhanced RR-DNS policy. If the work load permits, servers may be automatically throttled down or put into sleep mode to save power. The front-end server 200 may calculate the most efficient use of the back-end servers 210. It may be the case that all back-end servers are throttled down, but none are put into sleep mode to minimize power consumption. In other cases, some or all back-end servers may be throttled down and none put into sleep mode. Various permutations of throttling up/down and sleep/wake mode may be combined to yield the most power efficient configuration, depending on predetermined policies.

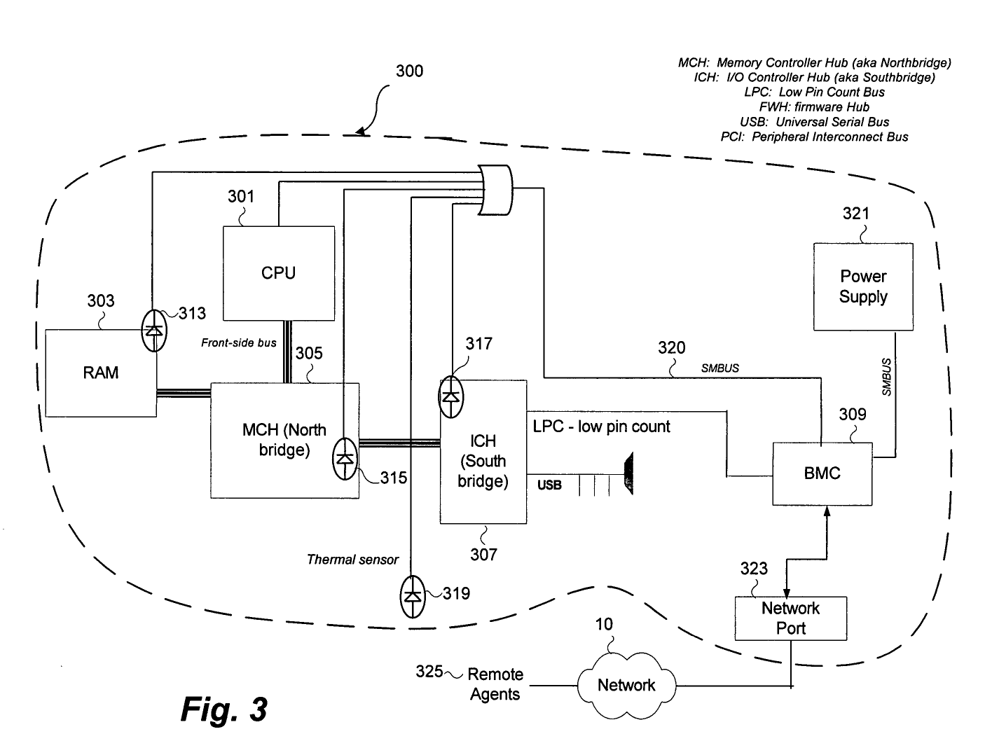

The front-end server 200 may communicate with the back-end servers 210 via an out-of-band connection to determine the power dissipation and load of the back-end server. FIG. 3 is a block diagram of an exemplary back-end server communicatively coupled to the front-end server. Server 300 may comprise a processor 301 communicatively coupled with memory 303 via a memory controller hub (MCH) 305, also known in some systems as a “north bridge.” Processor 301 can be any type of processor capable of executing software, such as a microprocessor, digital signal processor, microcontroller, or the like. Though FIG. 3 shows only one such processor 301, there may be one or more processors in the server 300 and one or more of the processors may include multiple threads, multiple cores or the like. Memory 303 can be a hard disk, a floppy disk, random access memory (RAM), read only memory (ROM), flash memory, or any other type of machine medium readable by processor 301.

The MCH 305 may be communicatively coupled to an input/output (I/O) controller hub (ICH) 307, also known as a “south bridge,” in some systems. The ICH may be coupled to a baseboard management controller (BMC) 309 via a low pin count (LPC) bus. Various components of the platform 300 may have sensors 313, 315, 317 and 319 which communicate information to the BMC via the system management bus (SMBUS) 320. For instance, thermal sensor 319 may communicate a platform temperature to the BMC for further processing, or transmission. Sensors 313, 315, 317 and 319 may be thermal diodes for measuring ambient temperature. Other types of sensors may be used such as analog-to-digital converters (ADC) for measuring current (I) dissipated or voltage (V) supplied, where Power=V*I.

The BMC 309 may be coupled to the power supply 321, as is typical in existing server systems, via the SMBUS 320. The SMBUS interface may communicate Intel® platform management interface (IPMI) messages or vendor-specific messages. IPMI messages may be used for many platforms available from Intel Corporation. More information about IPMI may be found on the public Internet site at URL developer-intel-com/design/servers/ipmi/. These messages may provide temperature, ADC readings and other information read from the sensors. An SMBUS is analogous to an on-board sensor network. This enables the BMC to receive power dissipation information. The BMC may be communicatively coupled to a network, such as the Internet 10, via a network port 323. One or more remote agents 325 may communicate with the BMC via this out-of-band connection.

A variety of communication protocols may be used to garner information from the BMC. For instance, in an embodiment, a Remote Management Control Protocol (RMCP) message may be used to communicate with the BMC. RMCP is specified in the Distributed Management Task Force “ASF 2.0” specification. (See “Alert Standard Format (A S F) Specification Version 2.0”, 23 Apr. 2003, Distributed Management Task Force, Inc.), also found on the public Internet at URL www-dmtf-org. In some embodiments, a remote agent 325 may send an RMCP message to the IPMI controller (not shown) of the back-end server 300 to effect the reading of sensors 313, 315, 317 and 319. For instance, a thermal sensor 319 may be read by the BMC 309 via a 2 wire bus (SMBUS) 320. The sensors may return data on temperature or power dissipation, or other relevant data.

An embodiment of the invention describes a means by which the platform power utilization in a data center may be minimized. Herein, the “platform” is generalized to be an ensemble of back-end servers in a data center that masquerade as a single unit. In an embodiment, an eRR-DNS front end server is responsible for representing a single IP address, such as that for common top level search engine domain. The front-end server distributes the user accesses/requests to a collection of back-end servers that are on a network behind the eRR-DNS and not exposed to the public network. An embodiment augments the typical RR-DNS algorithm by adding power utilization information and policy to the load balancing algorithm. This eRR-DNS server uses the power-utilization of a given back-end server as a criteria for dispatching requests. More formally, in additional to maximizing Rate, the eRR-DNS server will minimize Power, e.g., Max {R}, Min {P}. In some embodiments, a power consumption may be measured as millions of instructions per second (MIPS) per Watt per cm³, where MIPS is measured as the throughput or load that a server can support. Watts is the power dissipation per server. Cm³ is the space that the server occupies, or simply the number of physical servers that may be placed on the rack. There may be a megawatt limit, for instance, in a single room, due to air conditioning limitations. If this parameter is exceeded then it may be desired to sleep a maximum number of servers. A measured rate may be transactions per second. Jobs or transactions may be weighted based on perceived difficulty.

In an embodiment, back-end servers may use Windows™ management instrumentation (WMI) to communicate with the front-end server using IPMI inside the box and web services for management extension (WMX) for communication over a web service. WMX may use an IPMI message over an HTTP request using simple object access protocol (SOAP) XML formatted messages (in-band or out-of-band message).

Using WS-management and WMX, the eRR-DNS host machine may send a SOAP message to the web servers and request a catalog. The catalog will have the power dissipation on each server.

A simple protocol may be to round robin but skip a sleeping server, or round robin but throttle down processors. Each server farm may perform power management policy, where the front-end server performs round robin to number of server farms. The individual server farms may abide by the power management policies.

For instance, when there are no requests, the servers may be throttled down in order to save power over the long term. When there is a request, the servers may be powered up, each in turn, or based on power consumption. As the request load increases and successive server power increases, each server may be successively throttled down in order to maintain overall power set-point and load on each machine. When power set-point cannot be maintained and each server is at maximum load, successive requests will be failed.

If the running platforms are dissipating too much heat, then a policy may be to drop transactions, or increase user wait time. Quality of service may go down.

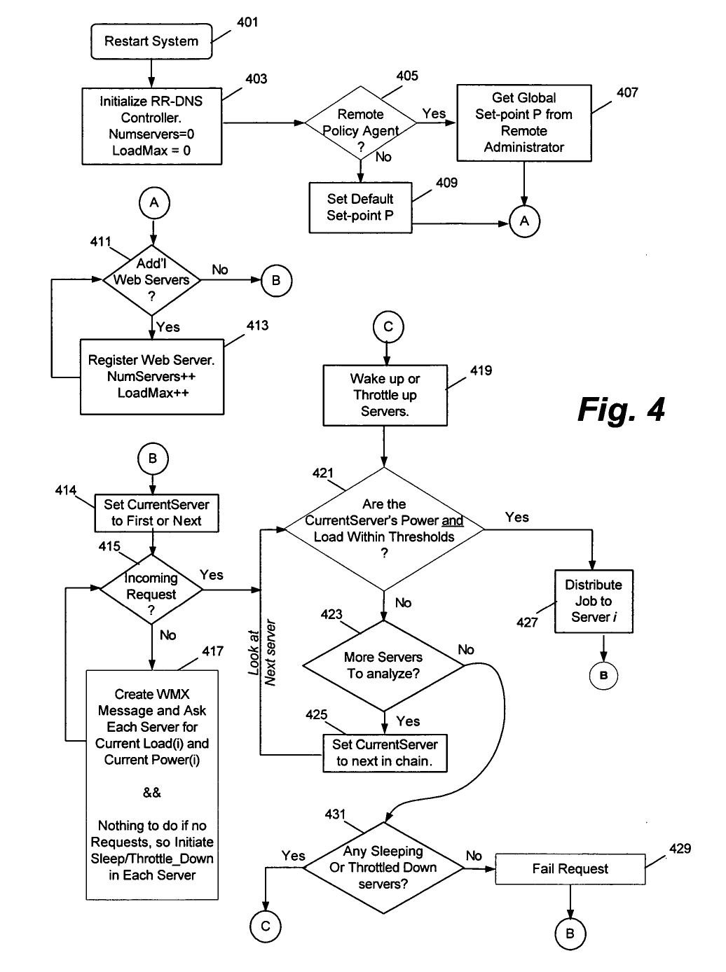

FIG. 4 shows an exemplary method for power management of a plurality of servers, according to an embodiment as shown in FIGS. 2 and 3. In an embodiment, the front-end system (200) may be restarted in block 401. The front-end system 200 may have an enhanced RR-DNS policy which includes power management. Initialization of specific variables to be used in the power management algorithm, such as NumServers (number of servers available) and LoadMax (maximum load permitted) may be performed in block 403. In an embodiment, these variables are set to zero in the initialization phase. It is determined whether a remote policy agent (325) is to be used in block 405. If so, a global set-point P may be retrieved from the remote administrator in block 407. The set-point P dictates how much overall power that the rack can use. This value P may be a combination of the cooling capabilities of the data center, the power-infrastructure, and the cost model for depreciating the equipment for expected performance. If no remote policy agent is to be used, then a default set-point P is set in block 409.

In an embodiment, for each web server (back-end server 210) identified, NumServers, is incremented to determine the total number of servers available in the loop of blocks 411 and 413. As each server is identified, it is registered on the network (413). A server is registered with an eRR-DNS agent as being available to service requests and as having a specific power dissipation. The maximum load available (LoadMax) is incremented as each server is identified, as well. LoadMax is the maximum number of requests that the server can host. Available servers may be polled in a variety of ways to ascertain whether they are available to perform work requested by the front-end server. The availability to do work may be inferred by a front-end server redirecting an HTTP “Get” message or HTTP “Post” message to a back-end server. The back-end server may reply with an HTTP “Busy” message. Alternatively, there may be a specific uniform resource identifier (URI), as described on the public Internet page www-gbiv-.com/protocols/uri/rfc/rfc2396.html, for each back-end server, where the back-end server replies with the number of outstanding transactions and amount of processor free time. The first alternative is inferential (i.e., infers that the back-end server is busy) and second alternative provides more exact reporting.

In preparation for receiving requests, a variable, CurrentServer, may be initialized to zero, or in other words, set to the first server in the chain, in block 414, to begin the request distribution process. When a user or other remote application requests a service to be performed, the request reaches the front-end server 200. When requests are not being received, as determined in block 415, the front-end server may communicate with the back-end servers to determine their current load and power dissipation, in block 417. It will be apparent to one of ordinary skill in the art that a variety of in-band and out-of-band communication protocols may be used to ascertain the required information. The polling for power and load information may continue at selected intervals until a new request is determined to arrive, in block 415. Further, when no requests are being received, back-end servers may be idle. If this is the case, then the front-end server may initiate sleep mode in idle servers, or throttle them down.

A variety of policies may be implemented to sleep or throttle down idle servers in block 417. In an embodiment, if all back-end servers are idle, then the front-end server may initiate sleep mode in each server. In another embodiment, servers may be throttled down, one by one, as they go idle. In this embodiment, a server is not put to sleep until all servers are throttled down. It will be apparent to one of ordinary skill in the art that a variety of policies may be used to determine when to sleep or throttle down an idle or under utilized back-end server.

If the front-end server determines that a new request is received in block 415, then the eRR-DNS policy may be used to balance the work load, while minimizing power consumption. In an embodiment, the new request may be sent to the “CurrentServer.” The algorithm determines which server is to be considered the “current” server based on power management and load balancing policies. If the CurrentServer is in sleep mode, the front-end server may initiate a wake event before sending a task to the CurrentServer. In some embodiments, the front-end server may choose to select a new CurrentServer that is already in wake mode, based on policy and power considerations.

A determination may be made as to whether the power dissipation (Pᵢ) of the CurrentServer is less than the set-point P/NumServers and that the load is within a desired threshold in block 421. This determination may be made using the following criteria: P(i)<P/NumServers && L(i)<LoadMax/NumServers, where Power P is the overall power dissipation of all servers and (Pᵢ) is the contribution to that maximum power of a single given server, and where load LoadMax is the maximum number of outstanding transactions that can be served and Lᵢ is the contribution to maximum load of the given single server. For instance, in an e-commerce scenario, a data center, or server farm, may process 10,000,000 transactions per hour. This number of transaction is the “load” that the back-end servers can support. LoadMax/NumServers is the fraction of the number of transactions that a given web server could presumably support. If both of these criteria are true, then the job may be distributed to the CurrentServer i in block 427.

If both criteria are not true for the CurrentServer, then it is determined whether there are more servers to analyze in block 423. If not, then a determination is made in block 431 as to whether there are any throttled or sleeping servers that may be throttled up or woken up in order to accommodate the request. If all servers are currently running, then at this point there is no power or load capacity to spare and a failure request is executed in block 429.

Otherwise, if there are further servers to analyze, the CurrentServer is incremented to represent the next server in the chain (i.e., round-robin portion of the algorithm) in block 425. Processing continues with 421 to determine whether the CurrentServer has power and load capacity. Thus, in this manner, each server in the round-robin chain is checked to determine whether the server can perform the request and maintain a minimum power dissipation.

In some cases, this algorithm may fail to find an available server, based on the selected set-point P and other criteria. In this case, the request will fail at block 429. It will be apparent to one of ordinary skill in the art that a variety of recovery procedures may be performed in 429 based on the desired policy. For instance, a failure may put the request in a queue to try again after a selected period of time. A count may be used to determine whether too many retries have occurred. An error message may be sent to the user or requesting application to notify the sender of the failure. In other cases, throughput may be identified as a more important priority and the set-point P may be modified and/or various processors may be throttled up to accommodate a heavier load. A variety of algorithms may be used to apply the desired policy. Once the request has been distributed (427), or a failure request has been acted upon (429), control passes to block 414 to reset the CurrentServer and to wait for additional requests and to poll for power and load information.

When there are no more servers to analyze, as determined in block 423, a determination may be made as to whether all of the servers have been powered down (sleep mode) in block 431. If so, the process may continue with block 419 to wake up the next server. In an embodiment, the next server in the chain is woken up to process the request. In other embodiments, servers are throttled up or woken up based on various power management policies. It will be apparent to one of ordinary skill in the art that various algorithms may be used to determine whether to wake/sleep or throttle the back-end servers.

In an embodiment, an alternative algorithm may be used, such as, a least recently used queue. By using a least recently used (LRU) queue, the most idle server is given the next request. In an embodiment with a heterogeneous mix of servers (i.e., some have better MIPS/WATT), it may be preferred to select the most efficient server in the ordering algorithm. It will be apparent to one of ordinary skill in the art that various algorithms may be used to accommodate available servers and data center air conditioning and power consumption requirements.

The techniques described herein are not limited to any particular hardware or software configuration; they may find applicability in any computing, consumer electronics, or processing environment. The techniques may be implemented in hardware, software, or a combination of the two. The techniques may be implemented in programs executing on programmable machines such as mobile or stationary computers, web servers, multi-threaded, single-threaded or multi-core processors, multi-processors, and other electronic devices, that may include a processor, a storage medium accessible by the processor (including volatile and non-volatile memory and/or storage elements), at least one input device, and one or more output devices. Program code is applied to the data entered using the input device to perform the functions described and to generate output information. The output information may be applied to one or more output devices. One of ordinary skill in the art may appreciate that the invention can be practiced with various system configurations, including multiprocessor systems, minicomputers, mainframe computers, independent consumer electronics devices, and the like. The invention can also be practiced in distributed computing environments where tasks or portions thereof may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine accessible medium having stored thereon instructions that may be used to program a processing system or other electronic device to perform the methods. The term “machine accessible medium” used herein shall include any medium that is capable of storing or encoding a sequence of instructions for execution by the machine and that cause the machine to perform any one of the methods described herein. The term “machine accessible medium” shall accordingly include, but not be limited to, solid-state memories, optical and magnetic disks, and a carrier wave that encodes a data signal. Furthermore, it is common in the art to speak of software, in one form or another (e.g., program, procedure, process, application, module, logic, and so on) as taking an action or causing a result. Such expressions are merely a shorthand way of stating the execution of the software by a processing system cause the processor to perform an action of produce a result.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. A system, comprising:
a front-end server to assign jobs to a plurality of back-end servers, wherein the front-end server determines which of the plurality of back-end servers is to receive a next job based on an analysis of throughput and power consumption of the plurality of back-end servers; and
the plurality of back-end servers to receive jobs assigned by the front end-server, wherein the plurality of back-end servers are communicatively coupled to the front-end server, and wherein each of the plurality of back-end servers at least one of reduces and increases power consumption when requested to do so by the front-end server.

2. The system as recited in claim 1, wherein the front-end server assigns jobs using a round-robin technique enhanced by power policy criteria.

3. The system as recited in claim 2, wherein the power policy criteria maximizes transactions per unit time and minimizes power consumption of the plurality of back-end servers.

4. The system as recited in claim 3, wherein the power consumption of a back-end server is communicated to the front-end server via an out-of-band protocol.

5. The system as recited in claim 3, wherein the power consumption of a back-end server is communicated to the front-end server via an in-band protocol.

6. The system as recited in claim 1, wherein reducing power consumption comprises at least one power reduction means selected from a group of power reduction means consisting of putting a back-end server into sleep mode and throttling down clock speed of a back-end server.

7. The system as recited in claim 1, further comprising a plurality of sensors communicatively coupled to a baseboard management controller (BMC), wherein the BMC is communicatively coupled to the front-end server to communicate readings from the plurality of sensors.

8. The system as recited in claim 1, wherein the front-end server receives policy parameters from a remote agent.

9. A method comprising:
setting a set-point P as criteria for desired power consumption in a network of a plurality of back-end servers;
registering the plurality of back-end servers as available for job assignment;
determining a current load and a current power consumption for each back-end server registered;
receiving a job request from a remote party;
determining a back-end server of the plurality of back-end servers to which the received job request is to be assigned, the assignment based on an analysis of transaction rates and power consumption of each back-end server.

10. The method as recited in claim 9, wherein determining a current load and a current power consumption comprises receiving sensor data from each back-end server via a baseboard management controller coupled to each respective back-end server.

11. The method as recited in claim 10, wherein determining a current load and a current power consumption further comprises identifying a transaction rate for each back-end server using job start and job end times for previous job assignments.

12. The method as recited in claim 11, wherein identifying a transaction rate for each back-end server further comprises weighting job assignments by difficulty.

13. The method as recited in claim 9, wherein analysis of transaction rates and power consumption of each back-end server maximize a number of transactions per server and minimize overall power consumption, wherein a the plurality of back-end servers are weighted by power and throughput efficiency to determine a best server to assign the job request.

14. A machine accessible medium having instructions that when accessed cause the machine to:
set a set-point P as criteria for desired power consumption in a network of a plurality of back-end servers;
register the plurality of back-end servers as available for job assignment;
determine a current load and a current power consumption for each back-end server registered;
receive a job request from a remote party;
determine a back-end server of the plurality of back-end servers to which the received job request is to be assigned, the assignment based on an analysis of transaction rates and power consumption of each back-end server.

15. The medium as recited in claim 14, wherein determining a current load and a current power consumption comprises receiving sensor data from each back-end server via a baseboard management controller coupled to each respective back-end server.

16. The medium as recited in claim 15, wherein determining a current load and a current power consumption further comprises identifying a transaction rate for each back-end server using job start and job end times for previous job assignments.

17. The method as recited in claim 16, wherein identifying a transaction rate for each back-end server further comprises weighting job assignments by difficulty.

18. The method as recited in claim 14, wherein analysis of transaction rates and power consumption of each back-end server maximize a number of transactions per server and minimize overall power consumption, wherein a the plurality of back-end servers are weighted by power and throughput efficiency to determine a best server to assign the job request.
